(19) United States
(12) Patent Application Publication
(10) Pub. No.: US 2007/0182113 A1
(43) Pub. Date: Aug. 9, 2007

(54) Portable recreational storage unit and kitchen

(76) Inventors: Wayne McCutchen, Sparrow Bush, NY (US); Rebecca McCutchen, Sparrow Bush, NY (US)

Correspondence Address: Raymond M. Galasso;Galasso & Associates LP, P.O. Box 26503, Austin, TX, 78755-0503, US

(21) Appl. No.: 11/347,976

(22) Filed: Feb. 6, 2006

(51) Int. Cl. B62B 3/00

(52) U.S. Cl. 280/47.35

(57) ABSTRACT

A portable storage unit designed for transporting a variety of items including but not limited to food items and fishing equipment. The portable storage unit includes integrally mounted cooking devices to facilitate preparation of a meal. The portable storage unit further includes a plurality of walls, a bottom and top forming a container. The container includes compartment dividers. The portable storage unit is configurable such that snow skids or wheels can be utilized for transportation across different types of terrains.

### FIELD OF THE INVENTION

The present invention relates to a device for transporting recreational equipment and meal preparation, more specifically but not by way limitation a portable storage unit configured with a plurality of specialized compartments and devices configured to facilitate the storing and preparing of food along with recreational hardware such as fishing gear.

### BACKGROUND

The number of participants involved in the sport of fishing is one of the highest for all sports in the world. Fishing is enjoyed by millions of individuals every year for recreational pleasure as well as professionally. Fishing occurs in a variety of geographical regions in a multitude of climates. From surf fishing in tropical regions to ice fishing in northern regions, there exist common needs for individuals engaged in the sport.

Participants usually require at least a minimum of equipment such as an assortment of rods, reels, line, lures and other common fishing tools. Individuals choosing to utilize a fishing location that requires transportation of their equipment by walking to a remote area such as a pond or a distant location across a frozen lake have a need to be able to transport their gear with a single trip to the desired location.

Another need arises for the transportation and subsequent method of preparing a meal. This need arises out of the fact that the average length of time a participant engages in the sport is usually more than four hours for a single occurrence. No current devices have been shown to assist participants engaged in the sport fishing adapted to assist the participant in the transportation of the desired fishing equipment as well as transporting, storing, and preparing food.

Another problem occurs when the participant engages in the sport of fishing during hours of darkness. Many species of fish are sought after during the nighttime hours. It would be desirable for a fisherman to include a device that could provide light in order to provide the participant good visibility as needed.

Accordingly, there is a need for a device that can be transported across a plurality of surfaces such as but not limited to ice and rough terrain that provides storage for the desired fishing equipment and food and further include a method for preparing the food. Furthermore, this device should include an apparatus that is capable of producing light.

### SUMMARY OF THE INVENTION

It is the object of the present invention to provide a portable recreational storage unit combined with cooking devices that can be easily transported across a plurality of terrains.

Another object of the present invention is to provide a portable recreational storage unit that has at least one compartment specifically designed for storing fishing equipment.

It is a further object of the present invention is to provide a portable recreational storage unit that contains an insulated compartment for storing food items.

Yet another object of the present invention is to provide a portable recreational storage unit that has at least one method of cooking food items.

Another object of the present invention is to provide a portable recreational storage unit that is specifically adapted for traversing an ice surface.

Still another object of the present invention is to provide a portable recreational storage unit that is specifically adapted for traversing rough terrain

To the accomplishment of the above and related objects the present invention may be embodied in the form illustrated in the accompanying drawings. Attention is called to the fact that the drawings are illustrative only. Variations are contemplated as being part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 illustrates a perspective view of an embodiment of the present invention; and

FIG. 2 illustrates a side view of an alternative embodiment of the present invention.

### DETAILED DESCRIPTION

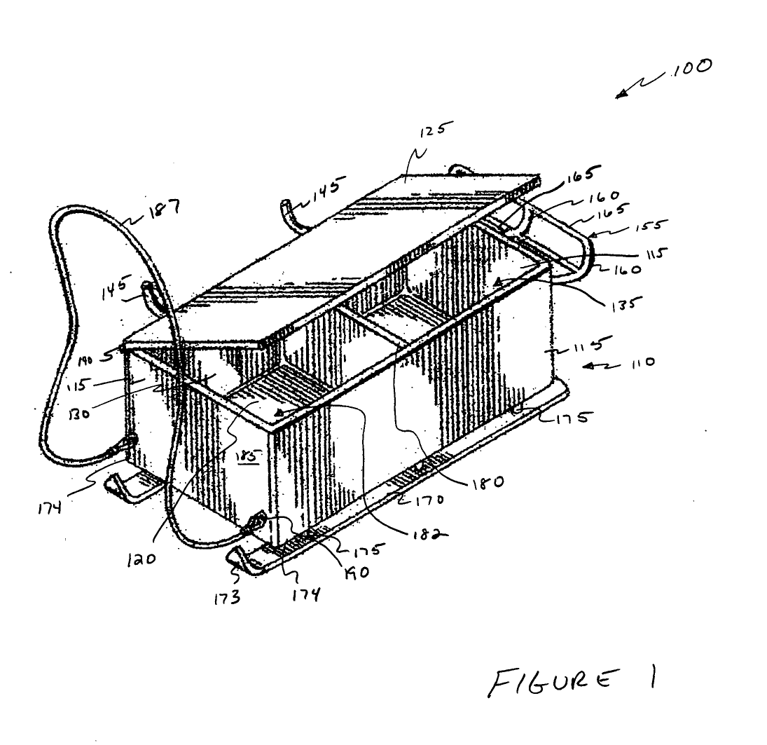

Referring now to the drawings, wherein various elements are not necessarily drawn to scale, and in particular FIG. 1, there is portable storage unit 100 constructed according to the principles of the present invention.

The portable storage unit 100 comprises a substantially hollow and rectangular container 110. The portable storage unit 100 has four walls 115 and a bottom 120 configured to define an interior volume with an opening 135. The four walls 115 and the bottom are constructed of a suitable rigid material such as but not limited to wood, metal or plastic. The four walls 115 and bottom 120 are attached by standard chemical or mechanical methods. Furthermore, it is also contemplated within the scope of the present invention that the four walls 115 and bottom could be manufactured integrally formed using conventional injection-molding techniques. It is also contemplated within the scope of the present invention that the four walls 115 are manufactured with a suitable insulation contained therein to provide thermal isolation of the contents in the container 110. Although the present invention is illustrated as having four walls 115, it is contemplated within the scope of the present invention that numerous different wall configurations are possible to construct the portable storage unit 100 with the desired functionality as described herein.

Proximate to the opening 135 is lid 125. Lid 125 is hinged the top of the side wall 130 is the lid 125. The lid 125 is configured in a substantially planar manner and is generally rectangular in shape. The lid 125 is sized so that it completely covers the opening 135. The lid 125 is manufactured from a suitable rigid material such as but not limited to plastic, wood or metal. The lid 125 is hingedly secured to the rear wall 150 with a conventional mechanical hinge 140.

Attached to the side wall 130 proximate to and beneath the lid 125 are a pair of retaining brackets 145. The retaining brackets 145 extend outward from the rear wall 150 and are with sufficient distance therebetween to receive thereon a generally long tool such as but not limited to an ice auger. While no specific measurements are required, good results have been achieved with a distance between the retaining brackets 145 measuring approximately thirty inches. The retaining brackets 145 are generally arcuate in shape so as to assist in capturing any tool placed therein. The retaining brackets 145 are made from a suitable rigid material such as but not limited to aluminum. The retaining brackets 145 are attached to the side wall 130 with conventional mechanical fasteners such as but not limited to bolts. Although the retaining brackets 145 are illustrated in the drawings submitted herewith as being generally arcuate in shape, it is contemplated within the scope of the present invention that the retaining brackets 145 could be manufactured in a variety of shapes to achieve the functionality suggested herein. More specifically but not by way of limitation, the retaining brackets 145 could be square in shape with an end opposite the side wall 130 that extends upward to assist in retaining items placed thereon.

Secured to the rear wall 150 is a motor bracket 155. The motor bracket 155 is mounted proximate to the opening 135 and generally projects outward from the rear wall 150. The motor bracket 155 is constructed of a suitable rigid material such as but not limited to aluminum. The motor bracket 155 is secured to the rear wall 150 with conventional mechanical fasteners such as but not limited to bolts. The motor bracket 155 is of sufficient length to accommodate a ice auger motor thereon. In the drawing submitted herewith, the motor bracket 155 is shown with three support legs 160 integrally formed with two parallel support members 165. Although this configuration is illustrated in the drawing submitted herewith, it is further contemplated within the scope of the present invention that the motor bracket 155 could consist of numerous different configurations of support members either in place of and/or in conjunction with the parallel support members 165 and support legs 160. It is within the scope of the present invention that the motor bracket 155 be constructed to receive thereon an ice auger motor or another large device to be transported.

The container 110 is superposed on a pair of skids 170. The skids 170 are mounted toward the outward opposing edges 174 of the bottom 120 and are generally configured in a parallel manner. The skids 170 are constructed of a suitable rigid material such as but not limited to plastic, metal or wood. The skids 170 are designed to facilitate the movement of the container across ice or snow. The skids 170 have a first end 173 that are curved upward. This allows the skids 170 to slidably traverse across snow or ice without the first end 173 of the skid 170 being temporarily captured on the surface much like conventional snow skis. Although the container 110 is shown in the drawings submitted herewith as having two skids 170, it is further contemplated within the scope of the present invention that the container 110 could have more or less than two skids 170 and perform the desired function suggested herein.

Interposed to the skids 170 and the bottom 120 are the skid supports 175. The skid supports 175 are positioned proximate to each corner of the container 110. The skid supports 175 are generally cylindrical in shape and manufactured from a suitable material such as but not limited to metal. The skid supports 175 have a first end and a second end. The first end of the skid supports are fastened to the bottom. The second end of the skid supports 175 are fastened to the skids 170. The skid supports 175 are fastened at each end by conventional methods such as but not limited to mechanical fasteners or chemical adhesion. Although the skid supports 175 are illustrated as being cylindrical in shape, it is further contemplated within the scope of the present invention that the skid supports 175 could be square.

Positioned internal of the four walls 115 and contiguous therewith is a divider 180. The divider 180 is positioned so that it bisects the container 110 into generally equal compartments. The divider 180 is constructed of a suitable rigid material such as metal, plastic or wood. The divider 180 is of suitable height so that it effectively partitions the container without interfering with the closure of the lid 125. The divider 180 is removably secured within the container so that a user can alter the internal configuration of the container in order to place desired objects therein. Although the container 110 is shown with a single divider 180, it is contemplated within the scope of the present invention that numerous dividers 180 could be present to allow for multiple configurations of the interior of the container 110. More specifically but not by way of limitation, numerous small dividers could be removable secured within the container in order to accommodate small items such as but not limited to fishing tackle. It is also further contemplated in the scope of the present invention that the divider 180 be manufactured with an insulating material in order to provide thermal isolation to at least one of the compartments 182.

Secured to the front wall 185 is a pulling device 187. The pulling device 187 provides the user an interface that allows the user to pull the portable storage unit 100 across the desired surface. The pulling device 187 is a flexible material such as but not limited to rope. The pulling device 187 is releasably secured to the front wall 185 with conventional eye bolts 190. The eye bolts 190 are mounted parallel superposed to each skid 170 to the front wall 185 proximate to the bottom. Those skilled in the art will recognize that numerous different materials could be used in place of and/or in conjunction with a rope to construct the pulling device 187 and achieve the desired function described herein. More specifically but not by way of limitation a t-shaped metal bar could be utilized.

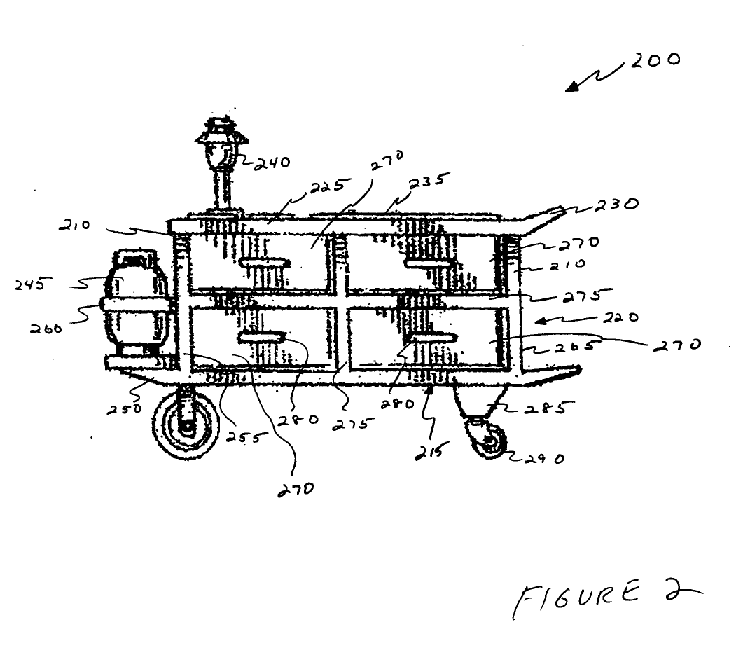

Now referring in particular to FIG. 2, there is illustrated an alternative embodiment of the present invention. As illustrated, the portable storage unit 200 comprises four walls 210 and a bottom 215 configured to form a generally rectangular shaped container 220 having an interior volume and an opening. The four walls 210 and bottom are constructed from a suitable rigid material such as but no limited to metal, plastic or wood. Although the portable storage unit 200 is illustrated as having four walls 210, it is contemplated within the scope of the present invention that the portable storage unit could have as few as one wall in a generally circular shape.

A top 225 is mounted opposite and parallel with the bottom 215 superposed on the four walls 220. The top 225 is configured in a substantially planar manner and is secured to the four walls 210 with conventional mechanical fasteners such as but not limited to screws. It is contemplated within the scope of the present invention that the top 225 could be hingedly attached similar to the first embodiment illustrated in FIG. 1. One end of the top 225 is formed to create a handle portion 230. The handle portion 230 is contiguous with the top 225 and extends outward from the top 225 at an angle in order to provide a surface that allows the user to transport the portable storage unit 200 across the desired terrain. Although no specific angle is required, good results have been achieved with a handle portion 230 that is manufactured at an angle range of five to forty-five degrees.

Integrally mounted into the top 225 is a plurality of propane appliances. A conventional propane grill 235 is mounted with conventional mechanical fasteners to the top 225. A propane lantern 240 is mounted adjacent to the grill 235. The grill 235 and the lantern 240 are supplied with propane fuel from the tank 245 that is secured to the front of the portable storage unit 200. The tank 245 is superposed on the tank support 250. The tank support 250 is contiguous with the bottom and extends beyond the front wall 255. The tank 250 is also secured to the front wall 255 with a strap 260. The strap 255 is fastened to the front wall 255 with conventional mechanical fasteners such as but not limited to bolts. The strap 255 is a semi-rigid material, such as but not limited to aluminum, that is shaped to bias against a standard propane tank. The strap 255 secures the tank to the portable storage unit 200 while the unit is being transported. Those skilled in the art will recognize that numerous different type of appliances could be used in place of and/or in conjunction with the propane appliances described herein. More specifically but not by way of limitation, the grill 235 could be a conventional charcoal or electric grill. It is further contemplated that the lantern could be a battery-powered lantern. Those skilled in the art will recognize that the grill 235 and lantern 240 could also be mounted to the lid 125 of the embodiment illustrated in FIG. 1.

Integrated into the side wall 265 and slidably mounted thereto is a plurality of storage compartments 270. The storage compartments 270 are supported by the compartment dividers 275. The compartment dividers 275 function to support and provide a suitable mounting surface for the storage compartments 270. The storage compartment 270 are conventional drawers that are manufactured from a suitable material such as but not limited to wood, metal or plastic. Handles 280 are mounted to each storage compartment 270 to provide a method of conveniently accessing the contents therein. The storage compartments 270 are mounted with conventional slidable drawer hardware to the side wall 265 and the compartment dividers 275. It is contemplated within the scope of the present invention that at least one of the storage compartments 270 could be constructed of an insulating material that would provide thermal isolation for the contents therein. Those skilled in the art will recognize that there are numerous possible configurations that could be used for the storage compartments 270. More specifically but not by way of limitation, the number or shape of storage compartments 270 could be varied. It is also contemplated within the scope of the present invention that the retaining brackets 145 and motor bracket 155 illustrated in FIG. 1 could be similarly mounted to the embodiment illustrated in FIG. 2.

Mounted to the bottom 215 and extending downward therefrom is a plurality of wheel brackets 285. The wheel brackets 285 are manufactured from conventional metal brackets and are designed to accommodate the wheels 290. The wheels 290 are conventional rubber wheels. It is preferred in the present invention that the wheels 290 are of a have a sufficient diameter and tread type so as to facilitate the transportation of the portable storage unit 200 across uneven and rough terrain. Although the illustration submitted herewith, shows 2 wheels from the side perspective, the preferred embodiment has four wheels 290 positioned generally near the corners of the portable storage unit 200. Those skilled in the art will recognize that numerous configurations of the wheels are possible. More specifically but not by way of limitation, the portable storage unit could utilize three wheels. Furthermore, it is contemplated within the scope of the present invention that other transportation methods could be utilized in place of and/or in conjunction with the wheels 290. More specifically but not by way of limitation skids made for transporting across ice or snow could be utilized to transport the portable storage unit 200.

Now referring in particular to FIG. 1, a description of the operation of the portable storage unit 100 is as follows. The user opens the lid 125 of the portable storage unit 100 mounted on the hinge 140. The user then places the contents desired for transporting into the plurality of compartments 182. The user then closes the lid 125. The user places an auger or other desired tool that will be required for tasks such as but not limited to drilling a hole for ice fishing on the retaining brackets 145. The user then places the auger motor or other desired tool on the motor bracket 155. To transport the portable storage unit 100 the user grasps the pulling device 187 and walks forward while holding the pulling device 187. The skids 170 allow the portable storage unit 100 to traverse across surfaces such as ice or snow easily. The user will transport the portable storage unit 100 to the desired location.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A portable storage unit for transporting items comprising:
a container having at least one wall and a bottom, said wall and bottom being configured to have an opening for receiving objects therein; and
a lid, said lid configured to substantially cover the opening of said container, said lid for closing the opening of said container, said lid being hingedly attached to said wall.

2. The portable storage unit as recited in claim 1, and further including at least one dividing wall, said dividing wall disposed internally of said container, said dividing wall configured to create compartments for receiving objects therein.

3. The portable storage unit as recited in claim 2, and further including two retaining brackets, said retaining brackets mounted proximate to said opening on said wall, said retaining brackets for supporting objects placed thereon.

4. The portable storage unit as recited in claim 3, and further including a motor bracket, said motor bracket mounted on said wall proximate to said opening and generally perpendicular to said retaining brackets, said motor bracket for receiving an auger motor thereon.

5. The portable storage unit as recited in claim 4, and further including at least one skid, said skid mounted to said bottom, said skid designed to allow said portable storage unit to be traversed across snow or ice.

6. The portable storage unit as recited in claim 5, and further including a pulling device, said pulling device attached to said wall, said pulling device configured for pulling said portable storage unit horizontally across a desired surface.

7. A portable storage unit for transporting fishing equipment and food items comprising:
a container, said container having a plurality of walls and a bottom, said plurality of walls and bottom being configured in a substantially rectangular manner and generally being hollow;
a top, said top being mounted on said plurality of wall opposite said bottom, said top including a handle portion on one end, said handle portion being angled upwards from said bottom;
a plurality of storage compartments, said storage compartments disposed within said container, said storage compartments slidably within said container; and
a movement device, said movement device being mounted to said bottom opposite said walls, said movement device configured to allow said portable storage unit to traverse across a plurality of terrains.

8. The portable storage unit as recited in claim 7, and further including a cooking appliance, said cooking appliance integrally mounted in said top, said cooking grill for cooking food items.

9. The portable storage unit as recited in claim 8, wherein said cooking appliance is a propane grill.

10. The portable storage unit as recited in claim 9, and further including a lantern, said lantern integrally mounted to said top adjacent to said cooking appliance, said lantern for providing light.

11. The portable storage unit as recited in claim 10, wherein said lantern is a propane fueled lantern.

12. The portable storage unit as recited in claim 11, wherein said movement device includes at least one of wheels and skids.

13. The portable storage unit as recited in claim 12, and further including a fuel tank support and strap, said fuel tank support contiguous with said bottom, said fuel tank support extending outward from one of said walls and being perpendicular thereto, said strap being above said fuel tank support and parallel thereto, said strap being mounted to one of said walls, said strap being configured to secure a conventional propane tank.

14. A portable storage unit adapted for transporting fishing equipment and food items across a plurality of terrains comprising:
a container, said container being configured with two side walls an rear wall and a front wall, said side walls, front wall and rear wall being configured with a bottom to create an opening for receiving objects therein, said container being rectangular in shape and hollow;
a top, said top being hingedly secured to one of said four walls, said top for closing said opening;
a plurality of dividing walls, said dividing walls disposed internally in said container, said dividing walls for creating a plurality of compartments for receiving items therein; and
a movement device, said movement device being removabley mounted to said bottom opposite said top, said movement device configured to allow said portable storage unit to traverse across a plurality of terrains.

15. The portable storage unit as recited in claim 14, and further including a pair of retaining brackets, said retaining bracket being arcuate in shape, said retaining brackets being secured to one of said side walls, said retaining brackets positioned thirty inches apart for receiving an auger thereon.

16. The portable storage unit as recited in claim 15, and further including a motor bracket, said motor bracket comprising three support legs, said support legs being formed with two parallel support members, said support legs being arcuate in shape, said motor bracket for receiving an auger motor thereon.

17. The portable storage unit as recited in claim 16, wherein said movement device is manufactured from a group of wheels or snow skis.

18. The portable storage unit as recited in claim 17, and further including a cooking appliance, said cooking appliance integrally mounted to said top, said cooking appliance being a propane grill.

19. The portable storage unit as recited in claim 18, wherein at least one of said dividing walls is insulated, said insulated dividing walls for providing thermal isolation from its external surroundings.

20. The portable storage unit as recited in claim 19, and further including a rope, said rope mounted to said front wall, said rope providing an interface for moving said portable storage unit.
